(19) United States
(12) Patent Application Publication
(10) Pub. No.: US 2006/0253500 A1
(43) Pub. Date: Nov. 9, 2006

(54) Method for validating system changes by use of a replicated system as a system testbed

(76) Inventor: Rajesh Kapur, Toronto (CA)

Correspondence Address: Rajesh Kapur, 264 Huntsmill blvd, Toronto, ON, NIW 396, CA

(21) Appl. No.: 11/414,679

(22) Filed: May 1, 2006

(30) Foreign Application Priority Data
May 4, 2005 (CA) 2,506,303

(51) Int. Cl. G06F 17/30

(52) U.S. Cl. 707/200

(57) ABSTRACT

A method for validating system changes by use of a replicated system as a system testbed wherein said system contains document management system software and a system database containing reference data to point to the document data within the system filestore, during maintenance or validation requirement to the primary system, the secondary replicated system can be used as a test environment, the method comprising steps of: creating a replicated server containing the system in which the reference data in the system database points to the primary system filestore and the system database tables mirror the primary, except those tables, containing reference information that uniquely identifies the replicated system from the primary production system; determining that a insert, update, delete/overwrite command has been issued on tables within the primary system database; and transferring and recording the commands from the primary system to the mirrored database system tables of the replicated system.

### FIELD OF INVENTION

As part of the management of a document management system the system database and filestore continue to grow in size. While this is a positive and desirable situation for the business as a whole, the company's data/Intellectual property is kept safe. This poses large problems systems people who need to maintain, upgrade these vast systems. the invention which allows the invaluable validation, testing of changes due to applying software/hardware patches, maintenance work, and perhaps upgrades on a real-time replica of the system; in this case of a Document management without risking the live system.

### DESCRIPTION OF THE RELATED ART

a method developed and presented at the Documentum Conference in Lisbon May 2004, “Upgrading to Documentum™ 5i using the Clean Build Toggle Clone Approach” http://www.momentumeurope.com/conf_track3.shtml. In this method a replicated server (document data within a system in a separate location, wherein the document data is stored in a system filestore associated with a system database) was built, upgraded, plurality of data was achieved but only at a point in time in order to switch or toggle the new replica to become the production system. The data was copied from the filestore using a full backup/restore on the Thursday night to the secondary backup store, on Friday night the Primary production server was shutdown and incremental backup and database export taken and these applied to the secondary server. This step ensured the plurality of the data for the point in time when after testing a switch could be made. This method forms one of the foundation stones of this Invention, however, suffers from the fallback that the two systems are only in sync for a point in time.

The second foundation stone of this invention is File number is co-pending application number CA2,504,070, CTC002 submitted Apr. 14^{th} 2005 for Patent in Canada, in which the concept of access preservation tables to record the data is developed. The third reference is that of fellow inventor Sandeep Jain Oracle Corporation U.S. Pat. No. 5,737,601A.

### BACKGROUND OF THE INVENTION

Many large companies use document management software. The purpose of such software is to help companies keep track of large volumes of documents in an organized way, so that documents can be easily stored, found and retrieved. In many cases, there will be more than one version of a particular document. Thus, version control is another aspect of most document management systems. Version control is an issue of particular importance in situations where different people are able to share documents and have shared access to the documents, including a shared right to independently modify the documents.

Documentum™ is a document management system that comprises of three different layers (or technologies) sitting on top of an operating system (server based) such as Unix™ or Windows 2000™ a system database, and a filestore.

The layers comprise of a Documentum™ application server layer that sits on top of the database and serves Documentum™ client interfaces. The reference information (i.e. the information pointing to the physical document data) and supplementary document information (i.e. the attributes of the types of Documents stored) are stored in the database. The actual physical data is stored in a filestore on either the server, a Storage area network (SAN)™ or Filer™ pointed to by the server.

One example of a company in which a document management software system would be useful is an engineering company that has many versions of the same part. When a client orders that part the company has to find the correct part version.

The document management system typically includes a system database that is associated with a filestore. The filestore stores the actual document data, while the system database stores reference information that points to the document within the filestore. Also, the system database typically stores supplementary document information regarding each document.

As part of the management of a document management system the system database and filestore continue to grow in size. While this is a positive and desirable situation for the business as a whole, the company's data/Intellectual property is kept safe. This poses large problems systems people who need to maintain, upgrade these vast systems. The problem posed is also complicated by the range of different technologies involved. The document management system having its own layers to manipulate the user entry and the separate stores of data namely the system database and the filestore which need to be maintained consistently.

For example every company needs to maintain the availability of these large systems stretching for some large companies into the terabytes of data. Should one of these systems experience problems, such as a performance problem or require a hardware or a Documentum™, or a database software patch there is currently no satisfactory way of handling, testing or validating these changes. The changes can be tested on a test system but this system never mirrors a real live production system and Stress testing is seldom carried out (real load testing where sometimes the real problems of performance degradation are found). Also documentum™ software databases need maintaining, tuning and effects of small changes need to be adequately studied. Often its required to carry these requirements out on live production systems this risks lack of validation and stress testing and considerable periods of problems, or downtime if the patch applied fixes one scenario but breaks another, or when a mistake gets made. This is unacceptable for most businesses, as some changes cannot be reverted.

With regards to major upgrades until very recently, most companies still preferred to completely write a new system and migrate the data across, some still do this, as the risk to their current system is so great. This invention does not cater for major upgrades, however, there it is advisable to sever the connection between the servers and use a copy of the filestore for the secondary system and use the approach as was presented by myself at the Documentum™ Conference in Lisbon May 2004, “Upgrading to Documentum™ 5i using the Clean Build Toggle “Clone” Approach”. The below approach was born out of a real-time critical problem. The filestore SAN™ storage that the Documentum™ management system was pointing to was running out of space. It was found that because the San drive was associated with NT server (on which the companies' documentum system was based on at the time couldn't actually be extended). As the systems Architect and Database Administrator it was my job to come up with the solution. I did this by cleanly building the said system on a new server (with the help of hardware and network professionals).

In this approach a replicated server, (The replica containing the proprietary document management system software and the system database containing reference data to point to the document data wherein said document data is stored in a separate system filestore associated with a system database ) was built, and upgraded, and hence plurality of data was achieved but only at a point in time that allowed a switch or toggle to allow the new replicated server to become the production system. In this procedure the data was copied from the primary filestore using a full backup/restore on the Thursday night to the secondary backup filestore. On Friday night the Primary production server was shutdown and incremental backup of the primary filestore and database export from the primary database taken and these applied to the secondary server. This step ensured the plurality of the data for the point in time when after testing a switch could be made. The approach forms one of the foundation stones of this Invention.

The second foundation stone of this invention is another invention File number 2,504,070 submitted recently for Patent in Canada, in which the concept of usage of Oracle™ triggers to record the metadata is developed, using a set of access preservation tables (Oracle™ tables, Sql Server™ tables).

The final foundation stone is the fact that most servers (such as a Unix™ or Windows 2000™ server) on which the Document Management/Oracle software sits on are Networked.

It is appreciated that this invention could additionally be used for the purpose of the secondary server acting as a “Standby” in case of failure of the first system's Server.

### SUMMARY OF THE INVENTION

What is required is a method for validating changes that need to be applied to the system these could be software or hardware patches or minor upgrades. The invention envisages doing this safely with no risk by using a replicated system as a system testbed updated constantly using data from the Production system which is modified by users this enables users to experience only positive changes to the system documents being managed by a document management system whilst system professionals being able to monitor, validate, add patches and small maintenance tasks before applying these to the production system on successful upgrade the systems could even be switched to allow the upgrade to take place on the primary system on unsuccessful upgrade the problem can be identified and fixed, the secondary system reverted to a previous state if possible, in any case the primary system is secured.

Accordingly, there is provided a method for validating system changes by use of a replicated system as a system testbed wherein said system contains document management system software and a system database which contains reference data to point to the document data within the system filestore, during mantainence or validation requirement to the primary system, the secondary replicated system can be used as a test environment, the method comprising steps of:
creating a replicated server containing the system in which the reference data in the system database points to the primary system filestore and the system database tables mirror the primary, except those tables, containing reference information that uniquely identifies the replicated system from the primary production system on the network fabric;
determining that a insert, update, delete/overwrite command has been issued on mirrored tables within the primary system database; and
transferring and recording the commands from the primary system to the database system tables of the replicated system.

Preferably, the primary system is operably connected to a network fabric. Preferably, the secondary system is operably connected to a network fabric. Preferably, the primary system has information loaded onto it, and is based on the first server. Preferably, the secondary system has information loaded onto it, and is based on a second server. Preferably, the first system and the second system is configured to allow a client computer operably connected to the network fabric to locate information owned by the first system and information owned by the second system. Preferably, the second system replicates the first system. Preferably, the system comprises a Document Management System residing on a server (Unix™ or Windows 2000™ server) comprising of a filestore storing the actual document data and a system database storing reference information pointing to the documents within a filestore, supplementary information on the document, together with system specific information. Preferably, the second system's system database is configured to mirror the information in that of the first system's system database less a portion of the data which allows the second system to be uniquely identified on the network fabric. Preferably, the filestore containing documents is connected to the network fabric. Preferably, the filestore is based on a Storage Area Network (SAN)™ or Filer™ connected to the network fabric. Preferably, the primary system's server can be connected to the filestore. Preferably, the secondary system's server can be connected to the same system filestore it is appreciated that a separate filestore for the secondary system can also be used and this is comprehended by the Invention in this case the second filestore in this case would need to have incremental backups from the first filestore to be continuously applied to it throughout. Preferably, the primary and secondary system share the same system filestore. Preferably, the primary and secondary system databases are linked through the network fabric. Preferably, the method comprises of using Oracle™ Database software linking primary and secondary system databases on the network fabric by means of an Oracle™ database link command. Preferably, in the case of a SQL Server™ database this link between primary and secondary system databases is by a means of a SQL server™ linked server command. Preferably, both the primary and secondary systems databases have the required access permissions to access, modify, insert or delete data in each other and are accessible to each other across the network fabric. Preferably, the method comprises document data being added to the filestore and reference data modified within system tables in the primary system database, and wherein the recording step comprises the step of recording reference data from all primary system tables, save those holding system specific data. Preferably, the primary system, in response to a insert, update, delete command, inserts, updates, deletes reference data to each of the system tables affected for each particular transaction. Preferably, the recording step comprises recording the reference data using at least one database trigger. Preferably, the recording step comprises recording the reference data using three database triggers associated with each system table, excepting those tables, which allow the first system to be uniquely identified on the network fabric. Preferably, the method comprises adding a first database trigger associated with recording the changes after an insert command on each table, adding a second database trigger associated with recording the changes after an update command on each table and adding a third database trigger associated with recording the changes after a delete command on each database table, excepting those tables that define the primary system on the network fabric. Preferably, the method comprises performing identical changes, to that which can occur after an insert, update, delete command on each primary system database table and are recorded within the respective database trigger pertaining to that particular transaction to the identical replicated secondary system database table, by means of the salient SQL command contained within the three triggers on each of the primary database tables, the transfer, and application of the identical SQL command made possible only by the primary and secondary database systems being linked through a database link on the network fabric. Preferably, the three triggers on each table in the primary database also record the changes on update, insert, delete to access-preservation tables and a single transaction table for all changes on all tables. Preferably, the single transaction table contains the group: the type of transaction ( i.e. update, delete, Insert), the system table on which the transaction is performed, the primary key of the table, and a Date-timestamp. Preferably, the recording step comprises using at least one access-preservation table. Preferably, the recording step comprises using a set of three access preservation tables for each primary system table to be mirrored in the secondary's database tables. Preferably, the method additionally comprises using a database stored procedure to apply the changes and transactions recorded in the access-preservation tables and transaction table, to the secondary system should the database link be severed for any reason including that of maintenance to the secondary system on a time based input parameter, once the database link is restored and user input is halted temporarily. Preferably, a set of database procedures can be used in contingency the database link is severed for any reason to apply the changes and transactions recorded, in order, from the time the link was severed to the secondary system in order to synchronise the two systems once the database link is restored again, user input to be halted at this point until the procedures have finished running, then the system can be returned to the said automated transfer using the SQL command within the triggers on each table, with the user input recommenced. Preferably, the set comprises a first access-preservation table to receive reference data recorded from the insert transaction on each system table, a second access-preservation table to receive reference data recorded from the update transaction on each system table, and a third access preservation table to receive reference data recorded from the delete transaction on each system table. Preferably, the method comprises input restriction until the primary and secondary system databases are re-synchronised. Preferably, the method comprises the contingency of applying the changes through at least a single database procedure using the combination transaction table and access-preservation tables, in order to resynchronise the primary and secondary systems once the database link is restored. Preferably, the method, comprises using Documentum™ as the Document Management System for both the primary and secondary system. Preferably the method comprises of using the primary system for the user community to store their documents. Preferably, the method comprises of using the secondary system as a testbed for changes which eventually need to be applied to the primary system. Preferably, the method comprises document data being added to the filestore and reference data modified within Documentum™ system tables in the primary Oracle™ system database, and wherein the recording step comprises the step of recording reference data from all primary system tables, save those holding server specific data. Preferably, the method requires the secondary system to be used as a testbed, for testing any changes before applying changes to the Primary system. Preferably, the secondary system can be also used as a standby backup system in case of failure of the primary system. Preferably, the primary and secondary systems can be interchanged by adding the database triggers and procedures to both primary and secondary system databases and disabling the triggers and procedures in the designated secondary system. Preferably, the system comprises a Documentum™ document management system, and wherein the method is carried out additionally it is appreciated that the secondary server be used as a “Standby” this is comprehended by this invention but is not the primary purpose. Preferably, the recording, inserting, updating, deleting and providing steps and standard database constructs are executed by the execution of Oracle™ database software code. Preferably, the recording, inserting, updating, deleting and providing steps and standard database constructs are executed by the execution of SQL Server™ database software code.

An example of the invention will now be described in detail with reference to the accompanying drawing in which;

### DRAWINGS

FIG. 1 is a schematic diagram of a system testbed according to a first embodiment of the invention.

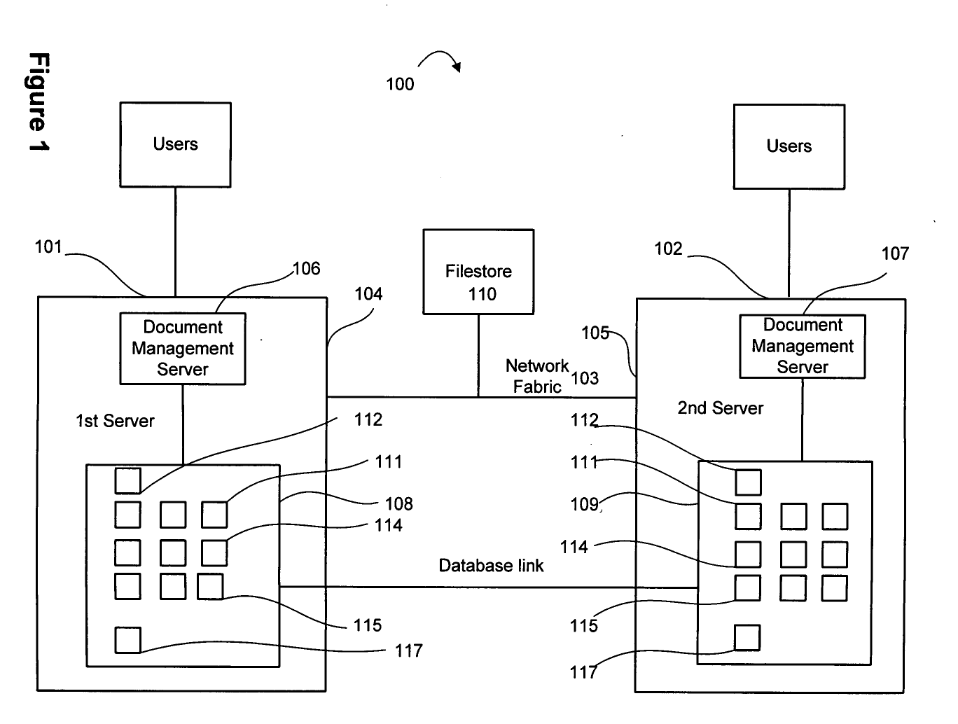

### DESCRIPTION OF THE INVENTION

[FIG. 1 shows the preferred form of the invention] FIG. 1 shows a system testbed 100 according to a first embodiment of the invention which allows the invaluable validation, testing of changes due to applying software/hardware patches, maintenance work, and perhaps upgrades on a real-time replica of the system; in this case of a Document management system known as Documentum™, without risking the live system. With the additional benefits that systems professional's can get users to thoroughly test including the additional benefit of being able to stress test e.g. carry out real load testing, with little or no time pressure; knowing that the primary system can be reverted to in case of failure due to changes.

A typical Documentum system database has a number of system tables that store reference information and supplementary document information. The Replicated server is set up using the approach presented at the Documentum Conference “Upgrading to Documentum 5i using the toggle “clone” method by myself.

The primary system 101 is operably connected to a network fabric 103. The secondary system 102 is operably connected to a network fabric 103. The primary system 101 has information loaded onto it, and is based on the first server 104. The secondary system 102 has information loaded onto it, and is based on a second server 105. The first system 101 and the second system 102 is configured to allow a client computer operably connected to the network fabric 103 to locate information owned by the first system 101 and information owned by the second system 102. The second system 102 replicates the first system 101. The system comprises a Document Management System residing on a server (Unix™ or Windows 2000™ server) 104, 105 comprising of a filestore storing the actual document data and a system database 108, 109 storing reference information pointing to the documents within a filestore, supplementary information on the document, together with system specific information. The second system's system database 109 is configured to mirror the information in that of the first system's system database 108 less a portion of the data which allows the second system 102 to be uniquely identified on the network fabric 103. The filestore containing documents is connected to the network fabric 103. The filestore is based on a Storage Area Network (SAN) or Filer 110 connected to the network fabric 103. The primary system's server 104 can be connected to the filestore. The secondary system's server 105 can be connected to the same system filestore. It is appreciated that a separate filestore for the secondary system 102 can also be used in an alternative embodment and this is comprehended by the Invention in this case, The second filestore in this case would need to have incremental backups from the first filestore to be continuously applied to it throughout. The primary 101 and secondary system 102 share the same system filestore. The primary and secondary system databases 108,109 are linked through the network fabric 103. Preferably, the method comprises of using Oracle™ Database software linking primary and secondary system databases 108, 109 on the network fabric by means of an Oracle™ database link command. Preferably, in the case of a SQL Server™ database this link between primary and secondary system databases is by a means of a SQL server™ linked server command. Both the primary and secondary systems databases have the required access permissions to access, modify, insert or delete data in each other and are accessible to each other across the network fabric 103. The method comprises document data being added to the filestore and reference data modified within system tables 112 in the primary system database, and wherein the recording step comprises the step of recording reference data from all primary system tables 112, save those holding system specific data. The primary system 101, in response to a insert, update, delete command, inserts, updates, deletes reference data to each of the system tables 112 affected for each particular transaction. The recording step comprises recording the reference data using at least one database trigger 111. The recording step comprises recording the reference data using three database triggers 111 associated with each system table, excepting those tables, which allow the first system to be uniquely identified on the network fabric 103. Preferably, the method comprises adding a first database trigger associated with recording the changes after an insert command on each table 112, adding a second database trigger associated with recording the changes after an update command on each table and adding a third database trigger associated with recording the changes after a delete command on each database table, excepting those tables 112 that define the primary system 101 on the network fabric 103. Preferably, the method comprises performing identical changes, to that which can occur after an insert, update, delete command on each primary system database table 112 and are recorded within the respective database trigger 111 pertaining to that particular transaction to the identical replicated secondary system database table 112, by means of the salient SQL command contained within the three triggers on each of the primary database tables, the transfer, and application of the identical SQL command made possible only by the primary and secondary database systems being linked through a database link on the network fabric. Preferably, the three triggers on each table in the primary database also record the changes on update, insert, delete to access-preservation tables and a single transaction table 117 for all changes on all tables. Preferably, the single transaction table contains the group: the type of transaction (i.e. update, delete, Insert), the system table on which the transaction is performed, the primary key of the table, and a Date-timestamp. Preferably, the recording step comprises using at least one access-preservation table 114. Preferably, the recording step comprises using a set of three access preservation tables for each primary system table to be mirrored in the secondary's database tables. Preferably, the method additionally comprises using a database stored procedure 115 to apply the changes and transactions recorded in the access-preservation tables 114 and transaction table, 117 to the secondary system should the database link be severed for any reason including that of maintenance to the secondary system on a time based input parameter, once the database link is restored and user input is halted temporarily. Preferably, a set of database procedures can be used in contingency the database link is severed for any reason to apply the changes and transactions recorded, in order, from the time the link was severed to the secondary system in order to synchronise the two systems once the database link is restored again, user input to be halted at this point until the procedures have finished running, then the system can be returned to the said automated transfer using the SQL command within the triggers on each table, with the user input recommenced. Preferably, the set comprises a first access-preservation table to receive reference data recorded from the insert transaction on each system table, a second access-preservation table to receive reference data recorded from the update transaction on each system table, and a third access preservation table to receive reference data recorded from the delete transaction on each system table. Preferably, the method comprises input restriction until the primary and secondary system databases are re-synchronised. Preferably, the method comprises the contingency of applying the changes through at least a single database procedure using the combination transaction table and access-preservation tables, in order to re-synchronise the primary and secondary systems once the database link is restored. Preferably, the method, comprises using Documentum™ as the Document Management System for both the primary and secondary system. Preferably the method comprises of using the primary system for the user community to store their documents. Preferably, the method comprises of using the secondary system as a testbed for changes which eventually need to be applied to the primary system. Preferably, the method comprises document data being added to the filestore and reference data modified within Documentum™ system tables in the primary Oracle™ system database, and wherein the recording step comprises the step of recording reference data from all primary system tables, save those holding server specific data. Preferably, the method requires the secondary system to be used as a testbed, for testing any changes before applying changes to the Primary system 101. Preferably, the secondary system 102 can be also used as a standby backup system in case of failure of the primary system 101. Preferably, the primary and secondary systems 101, 102 can be interchanged by adding the database triggers 111 and procedures 115 to both primary and secondary system databases 108, 109 and disabling the triggers and procedures in the designated secondary system 102. In this Embodiment the system 100 comprises a Documentum™ document management system, and wherein the method is carried out additionally it is appreciated that the secondary server be used as a “Standby” this is comprehended by this invention but is not the primary purpose. Preferably, the recording, inserting, updating, deleting and providing steps and standard database constructs are executed by the execution of Oracle™ database software code. Preferably, the recording, inserting, updating, deleting and providing steps and standard database constructs are executed by the execution of SQL Server™ database software code.

The triggers are added to the relevant Documentum™ tables and they automatically fire to capture the salient information needed to apply a SQL command to keep two systems synchronised, where the secondary system is a replica of the first. This transfer is made possible by the setting up of a Database link between the primary and secondary database systems across the network fabric. In this case an Oracle™ Database link. Permissions to the user schema or database on the secondary system need to be granted to the primary system's schema or database, and visa versa in case of the secondary system taking over the role of the primary. Additionally, the database link could be set up using other databases of course using the relevant construct, as I have some experience with Sql Server™ I can at least provide the database mechanism to link two Sql server databases together namely the “linked server” construct. Though my experience is mainly within the Oracle™ database orena, most large database of any stature have to have similar constructs through common standards such as the SQL command language itself. So this method is very much multi-database.

Below, there is shown sample code which can be extended to implement the invention the code is by no means complete but is sufficient to demonstrate the method. Code is given for Oracle™ only. One system table is taken dm_sysobject_r as example from the Documentum™ system though not all the columns are used for the example to merely show the concept of the three trigger a table system that is embodied by this invention. The concept is however explained.

The Invention can be embodied in a multi-operating system embodiment. The invention can be embodied in a multi-document management system embodiment. The invention can be implemented in a multi-database embodiment.

Oracle
Create Database link link_name
Connect to username Identified by password
Using sqlnet_string;
e.g.
Create Database link Secondary
connect to secondary identified by secondary
using ‘backup_database’

It is appreciated that in the case of an Oracle delete trigger (a before or after) trigger can be used, as is comprehended by the invention.

Create or replace trigger keep_del_r_trigger
before delete on dm_sysobject_r
for each row
Begin
delete from dm_sysobject_r@backup_database where
r_object_id = :old.r_object_id
Insert into keep_r_table value
(:old.r_object_id,:old.r_version_label,:old.i_folder_id,:SYSDATE);
Insert into transaction_table
(‘Delete’,‘dm_sysobject_r’,:old.r_object_id, SYSDATE);
EXCEPTION
when others then
RAISE;
END;
/

The first command of the above trigger shows the SQL command and the “after delete row” trigger on the primary database automatically deletes the row in the secondary table. The insert statement is necessary in case the link is severed which can happen from time to time in case of maintenance, or in case of failure. As the above Oracle code shows this can be used in order to preserve the data in access preservation tables and the transaction table. In this case instead of using the link to transfer the necessary commands; the access-preservation tables and transaction table are used instead at a later point by database procedures that can run in the transactions in sequence to the Secondary Database, or visa versa. The triggers and procedures being “Enabled” in the designated Primary.

Create or replace trigger keep_ins_r_trigger
after insert on dm_sysobject_r
for each row
Begin
insert into
dm_sysobject_r@backup_database(:new.r_object_id,
:new.r_version_label,:new.i_folder_{—id)}
Insert into keep_r_table value
(:new.r_object_id,:new.r_version_label,:new.i_folder_id:,SYSDATE);
Insert into transaction_table (‘Insert’,
‘dm_sysobject_r’,:new.r_object_id, SYSDATE);
EXCEPTION
when others then
RAISE;
END;
/

Notice the new values are used meaning the values after the insert or update of a row and these are subsequently used to apply changes to the secondary database.

Create or replace trigger keep_upd_r_trigger
after update on dm_sysobject_r
for each row
Begin
update dm_sysobject_r@backup_database
set r_version_label = :new.r_version_label,
i_folder_id = :new.i_folder_id where r_object_id = :new.r_object_id,
Insert into keep_r_table value
(:new.r_object_id,:new.r_version_label,:new.i_folder_id:,SYSDATE);
Insert into transaction_table
(‘Update’,‘dm_sysobject_r’,:old.r_object_id, SYSDATE);
EXCEPTION
when others then
RAISE;
END;
/

In the case of the dm_sysobject_r table above an example has been given of how the three triggers record the transactions for that table. This of course can be extended to every table within the system. A “before row delete” is used in the example, meaning the data the is about to be deleted is captured the :old values meaning whatever was there previously is always captured.

A “after row insert” and “after row update” is preferably used, meaning that the data values of the row that have been, inserted or updated are actually captured notice the new values inserted are always used. On a “before insert ” old values do not exist. This ensures that all salient and/or relevant information is captured.

It will be appreciated that an “after row delete” and “before row update/insert” could also be used and are comprehended by the invention. In such a case, the old values are captured immediately upon the deletion and the new values upon update and insert.

An oracle database procedure or stored procedure is a piece of oracle execution code and carries out logical instructions. An oracle trigger is a piece of application code that can be applied to an oracle “table” (a storage unit like a filling cabinet) which when particular transactions are carried out on the table it fires automatically to execute the code within it.

1. An apparatus for aiding real-time validation of system changes, comprising: a primary system based on a first server; and
a secondary system based on a second server, wherein the primary and secondary system are operable to be connected to a network fabric and attached to each other; and
wherein business information loaded onto the primary system initially is replicated onto the secondary system whilst the primary and secondary systems are unattached; and
further business information entered, altered, deleted and overwritten by the user base at real-time is continuously transferred from the primary system to the attached secondary system such that the secondary system is operable to achieve continuous synchronization and at real-time replicate the primary system; and
wherein the secondary system can be resynchronized to changes to business information upon the primary system after any breakage of the link for any reason using at least one transaction table and at least one database procedure once the secondary system is reattached such that the secondary system continues to be continuously synchronized; and
wherein the secondary system on successful upgrade validation is re-attached and interchanged to become the primary system.

2. The apparatus according to claim 1, further comprising information location means operable to allow at least one client computer connected to the said network fabric to locate first information owned by the primary system and second information owned by the secondary system.

3. The apparatus according to claim 2, wherein at least one of the first server and the second server comprises a document management system.

4. The apparatus according to claim 3, wherein the document management system comprises at least one filestore operable to store document data.

5. The apparatus according to claim 4, wherein the document management system comprises a system database operable to store reference information pointing to the document data within the filestore.

6. The apparatus according to claim 3, wherein the document management system comprises supplementary information about the document data and system specific information.

7. The apparatus according to claims 3, wherein the primary system and the secondary system share the same main filestore.

8. The apparatus according to any one of claims 1 to 7, wherein the primary system comprises a primary database and the secondary system comprises a secondary database.

9. The apparatus according to claim 8, wherein the primary database and the secondary database comprise database tables.

10. The apparatus according to claim 9, wherein the primary database and the secondary database are linked using a database network communication layer.

11. The apparatus according to claim 10, wherein the primary database and the secondary database are each operable to record and transfer changes to the database tables.

12. The apparatus as claimed in claim 1 wherein said breakage of the link includes any breakage during planned maintenance or upgrade to the secondary system, whilst the primary system continues to receive user input.

13. The apparatus according to any one of the claims 1 to 12, wherein the primary and secondary systems are interchangeable for any purpose.

14. The apparatus according to any of the claim 13, wherein the primary and secondary systems are interchangeable after successful upgrade of the secondary and resynchronization using the at least one database procedure and transaction table of the secondary system to the primary system.

15. A content management network-attached system according to claim 1 with native integration of a content management system and a storage system comprising:
a storage system for storing content data, content metadata, and business data.

16. The content management network-attached system of claim 1 further comprising:
a native unified replication system which automatically synchronizes replication of the content data, the content metadata, and business data.

17. The content management network-attached system according to claim 1 further comprising:
a native unified replication system which resynchronizes replication of the content data, the content metadata, and business data, on restoration of network attachment in the case of breakage of the attachment to the network attached system.

18. A method for aiding users, system professionals validate safely system changes during an upgrade by use of a replicated secondary system as a system testbed wherein the primary system contains document management system software further comprising a system database containing reference data to point to document data within a system filestore, the method comprising:
creating a replicated server containing a secondary system replicating the primary in which the reference data in the secondary system database points to the primary system filestore and system database tables in the secondary system mirror the database tables on the primary system based on a primary server, excepting those tables, containing reference information that uniquely identifies the secondary system from the primary system on a network;
determining that a insert, update, delete/overwrite command has been issued on tables within the primary system database; and
transferring and recording the issued commands upon the primary system' database to the mirrored database system tables of the secondary system;
detaching and carrying out the upgrade and validation on the secondary system whilst allowing input upon the primary system to continue; and
on successful validation, re-attachment and resynchronization the secondary system to the primary system interchanging the secondary system to become the new primary system.

19. The method according to claim 18, further comprising:
connecting the system filestore containing documents to the said network;
basing the system filestore on a storage system;
connecting the primary system's server to the system filestore; and
connecting the secondary system's server to the same system filestore.

20. The method according to claim 19, further comprising:
using database software to link primary and secondary system databases on the said network by means of a database link command;
using a network layer on the said network; and
allowing the primary database and the secondary database the required access to transfer and record necessary changes to both the primary and secondary' database tables.
